(19) United States
(12) Patent Application Publication
(10) Pub. No.: US 2004/0216968 A1
(43) Pub. Date: Nov. 4, 2004

(54) Disc brake pad

(76) Inventors: Giuseppe Donadoni, Dalmine (IT); Antonio Gotti, Almenno San Salvatore (IT)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 10/467,273

(22) PCT Filed: Jul. 17, 2002
(86) PCT No.: PCT/IT02/00460

(51) Int. Cl. F16D 65/38

(52) U.S. Cl. 188/73.47; 188/73.39

(57) ABSTRACT

A disc brake pad is suitable for cooperating with a fixed-caliper disc brake comprising a caliper body provided with a seat suitable for housing the pad. The pad seat is defined by a side wall with which the abutment surface of the plate of the pad is brought into abutment during braking.

The pad also has, on the surface for supporting the friction material, zones which are free of friction material and which advantageously obstruct the flow of heat from the friction material to the side walls of the pad seat.

### FIELD OF THE INVENTION

The present invention relates to a disc brake pad particularly for use in disc brakes for automotive use.

### BACKGROUND OF THE INVENTION

It is known that, in a normal operative condition of a disc brake in which the pad is housed in its seat in the caliper body, the pad is substantially surrounded by the material of the caliper body.

This condition is particularly evident in very compact constructions such as those with one-piece caliper bodies (formed as single castings) or caliper bodies comprising two half-bodies (each formed by casting) in which the seat for the pads is in the form of a pocket suitable for housing them.

In other words, in these constructions, the pads are in contact with the parts of the caliper (the walls of the seat which houses them, the pistons, and the like) for most of their surface area, leading to a marked heat flow from the pad towards the caliper which contains it, during braking.

This results in continual generalized overheating of the caliper body which translates into a deterioration of the mechanical characteristics of the material of which it is made, into boiling of the brake fluid, localized deterioration due to high-temperature fatigue, structural distortions (for example of the pad seats), and the like.

There is therefore a need to provide disc brake pads which can limit the flow of heat between the pad and the caliper body which houses it.

### SUMMARY OF THE INVENTION

The problem underlying the present invention is that of devising a disc brake pad which has structural and functional characteristics such as to satisfy the above-mentioned needs and at the same time to prevent the problems mentioned with reference to the prior art.

This problem is solved by a pad according to claim 1.

### BRIEF DESCRIPTION OF THE DRAWINGS

Further characteristics and the advantages of the pad according to the present invention will become clear from the following description of a preferred and non-limiting embodiment, in which:

FIG. 1 is a partially-sectioned, axonometric view of a disc-brake caliper comprising a caliper body and a pad according to the invention, housed in a seat of the caliper body,

FIG. 2 is a partially-sectioned axonometric view of a half-portion of the caliper body of FIG. 1 which houses the pad,

FIG. 3 is an axonometric view of the pad of FIG. 1,

FIG. 4a shows the pad of FIG. 3 in a front view which shows the friction material supported by the plate,

FIG. 4b shows the pad of FIG. 4a in a rear view,

FIG. 4c shows the pad of FIG. 3 in a side view,

FIG. 4d shows the pad of FIG. 3 in a plan view taken in the direction of the insertion of the pad in the seat of the caliper body, and

FIG. 5 is a front view of a further variant of the pad according to the invention.

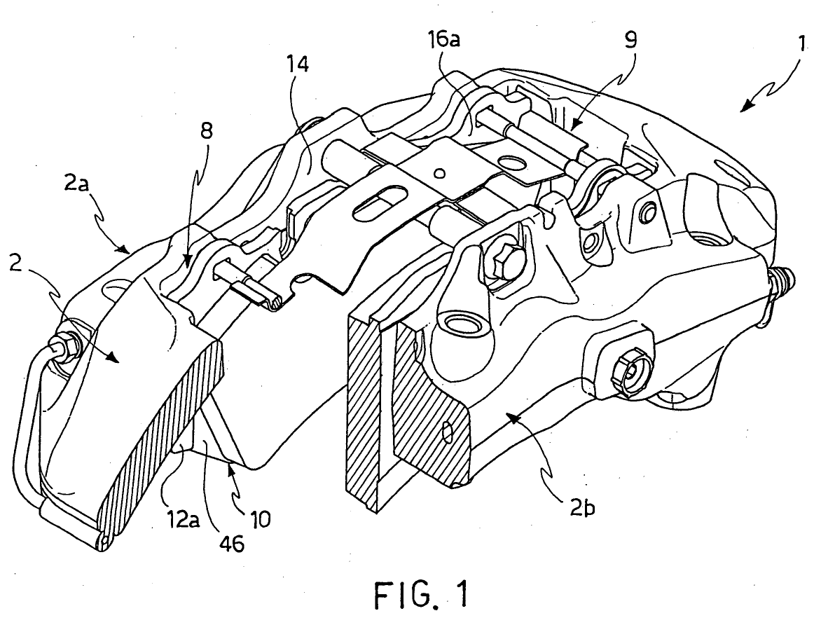

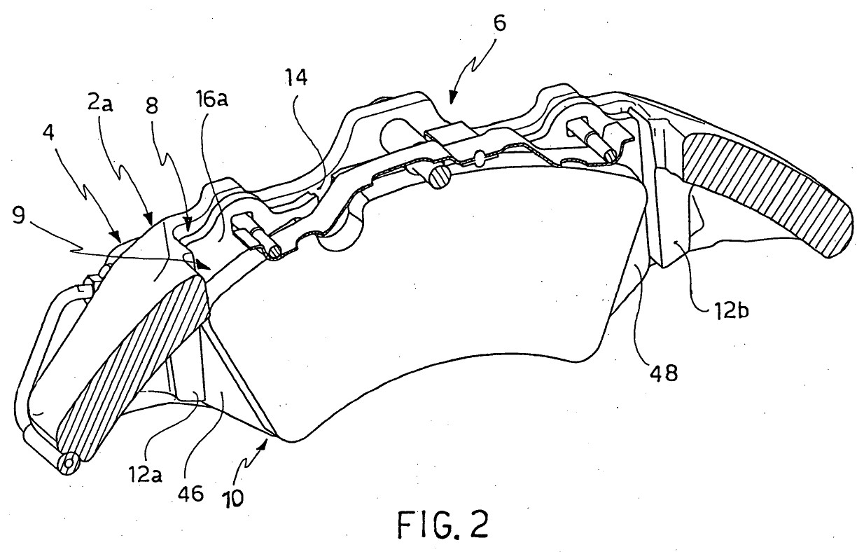

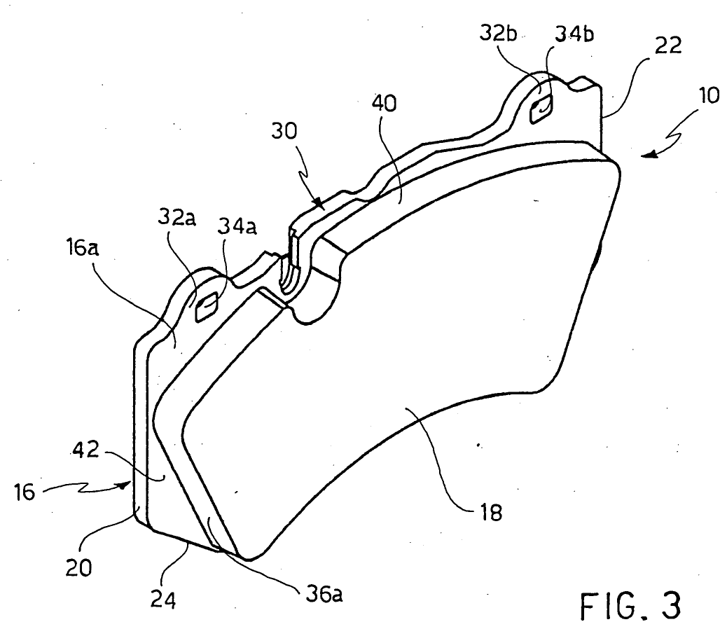

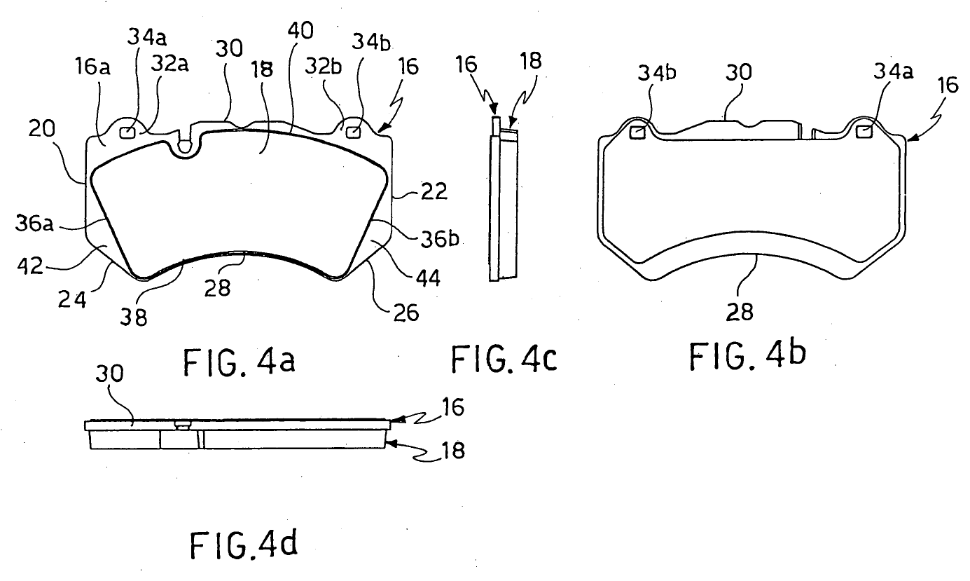

### DETAILED DESCRIPTION

With reference to the drawings, a fixed caliper for a disc brake, particularly for use in the automotive field, is wholly indicated 1.

The caliper 1 is to be fitted in a disc brake, astride a brake disc (not shown) fixed firmly to the wheel hub. The brake disc comprises a braking band which extends about an axis and has annular braking surfaces in planes that are parallel with one another and perpendicular to the axis.

The caliper 1 comprises a caliper body 2 fixed firmly to a portion of the vehicle (not shown) on which the disc brake is mounted.

In the embodiment described by way of example, the caliper body is formed in a single piece, that is, it is formed by a single casting. It is generally known as a “one-piece” caliper body.

In further variants, the caliper body is of the type formed as two half-bodies, for example, each produced by casting.

Irrespective of the method by which the caliper body 2 is produced, when the disc brake has been mounted on the user vehicle, the caliper body is arranged astride the brake disc, so that it is possible to identify an outer half-portion 2a of the caliper body 2 disposed between the vehicle wheel and the brake disc, and an inner half-portion 2b, disposed on the opposite of the disc to the outer half-portion 2a.

For the purposes of the present description, the two above-mentioned half-portions are substantially similar in structure and functional capacity and only one of them will therefore be referred to explicitly below.

When the disc brake has been mounted, a side covering region 4 of the half-portion 2a extends substantially so as to cover the braking surface of the brake-disc band. The outer half-portion also has an axial covering region 6 which at least partially spans the brake disc. In other words, the axial covering regions of the outer half-portion 2a and of the inner half-portion 2b of the caliper body 2 form the brake-disc cover which spans the disc.

The axial covering 6 has an opening 9 which can put the outside atmosphere into communication with the space inside the caliper body 2.

The outer half-portion 2a of the caliper body 2 has at least one seat 8 suitable for housing a pad 10.

According to one embodiment, the seat is produced by finishing machining operations performed on a semi-finished casting in order to define the abutment planes and the bearing surfaces, whilst achieving the desired tolerances.

A substantially parallelepipedal seat is preferably formed for the pad in the initial, semi-finished product, as a result of milling operations.

In other words, the seat 8 is configured as a pocket formed centrally in the outer half-portion 2a of the caliper body 2 and accessible from the axial covering region 6 thereof.

The seat is defined by a first side wall 12a and a second side wall 12b, as well as by a base wall 14. The side walls and the base wall, which are connected to one another continuously, form a type of housing, closed on at least three sides, for housing the pad 10.

The pad comprises a plate 16 having a support surface 16a for supporting friction material 18; the support surface 16a faces towards the braking surface of the brake-disc band when the pad 10 is housed in the seat 8 of the caliper body 2.

The plate 16, which fits the seat 8 of the caliper body 2, has a peripheral surface in which a first abutment surface 20 and a second abutment surface 22 can be identified.

Preferably, the first abutment surface 20 is parallel to and opposite the second abutment surface 22 and they are connected to a lower surface 28.

In a preferred embodiment, the first abutment surface 20 and the second abutment surface 22 are connected to the lower surface 28, respectively, by a first connecting surface 24 and by a second connecting surface 26 which are preferably not parallel to the abutment surfaces.

The peripheral surface of the plate 16 further comprises an upper surface 30 connected directly to the first abutment surface 20 and to the second abutment surface 22, on the side remote from the connecting surface 24 and from the second connecting surface 26, respectively.

In the region of the upper surface 30, the plate 16 also has a first projection 32a and a second projection 32b, in which a first through-hole 34a and a second through-hole 34b, which are preferably slot-shaped, are formed, respectively.

The friction material 18 of the pad 10 is shaped in a manner such that a first lateral region 36a and a second lateral region 36b are defined along its peripheral surface. When the friction material, thus shaped, is supported on the support surface 16a of the plate 16, the first lateral region 36a and the second lateral region 36b face towards the first abutment surface 20 and the second abutment surface 22 of the plate 16, respectively.

In a preferred embodiment, the friction material 18 of the pad 10 is shaped in a manner such that a lower arcuate region 38 and an upper arcuate region 40 are also defined along its peripheral surface. When the friction material, thus shaped, is supported on the support surface 16a of the plate 16, its lower arcuate region 38 substantially follows the lower surface 28 and its upper arcuate region 40 substantially follows the upper surface 30 of the peripheral surface of the plate 16.

The first lateral region 36a and the second lateral region 36b of the friction material 18 define on the support surface 16a of the plate 16, respectively, a first zone 42 and a second zone 44, which are free of friction material.

In other words, the lateral regions of the friction material 18 are not arranged parallel to the abutment surfaces of the plate 16 which they face towards but are recessed relative thereto, leaving the said zones free of further friction material.

The shaping of the friction material 18 is thus such that its lateral regions are appreciably spaced from the abutment surfaces of the plate 16, substantially representing spacer elements for spacing the friction material 18 from the abutment surfaces of the plate.

In one embodiment, the lateral regions of the friction material 18 are spaced from the abutment surfaces of the plate 16, and are recessed towards the interior of the plate 16.

In a preferred embodiment, the zones of the support surface 16a of the plate 16 which are free of friction material are substantially triangular, since the lateral region of the friction material, the abutment surface, and the connecting surface of the plate, which delimit them, are substantially flat.

In a preferred embodiment of the pad 10, the lateral regions of the friction material 18 adopt a substantially radial arrangement relative to the brake disc with which the caliper body which houses the pads can be associated.

The pad 10 is suitable for being housed in the seat 8 of the caliper body 2, the seat being accessible from the opening 9 provided in the axial covering region 6 of the half-portion of the caliper body 2. In the above-mentioned insertion configuration, the pad is substantially enveloped by the material of the caliper body.

In this configuration, the first abutment surface 20 and the second abutment surface 22 of the plate 16 are arranged facing the first side wall 12a and the second side wall 12b of the seat 8 of the caliper body 2, respectively.

By virtue of the way in which the friction material 18 is shaped, the friction material is spaced from the side walls of the seat 8 of the caliper body 2 which face towards the abutment surfaces of the plate 16.

In other words, the zones 42, 44 of the support surface 16a of the plate 16 space the friction material 18 from the side walls of the seat 8 which houses the pad 10, creating a first recess 46 and a second recess 48, defined between the side wall of the seat 8 and the surface of the friction material 18.

In a configuration in which the caliper body is mounted astride the brake disc provided with the annular braking surfaces, the recesses are defined by the braking surface of the brake disc, as well as by the side walls of the seat 8 and by the lateral surfaces of the friction material 18.

In a mounted configuration of the disc brake, in which the caliper is arranged astride the brake disc, the braking surface of the band of the disc at least partially overlaps the zones of the pad 10 which are free of friction material.

In other words, if the braking surface of the brake disc is projected axially onto the support surface 16a of the plate 16, the projection also covers the zones of the support surface which are free of friction material.

Stated in yet another way, since the friction material 18 is spaced from the side walls of the seat 8 which houses the plate 16, its interaction with a portion of the braking surface of the brake disc during braking is avoided in the vicinity of the side wall 12a of the seat for the pad.

During braking, the pad 10 is moved towards the braking surface of the brake disc by suitable actuating means (not shown) such as hydraulic pistons or the like.

The friction material bears on and, by virtue of the actuation means, presses against, a portion of the braking surface of the brake disc, bringing about a braking action due to the frictional forces which are generated by the interaction of the friction material with the braking surface of the brake disc.

The pad 10, which is dragged along by the rotation of the disc, is brought into abutment with one of the side walls of the seat 8 which houses it. In other words, the pad 10 is dragged along by the rotating disc so that the first abutment surface 20 of the plate 16 is brought into abutment with the first side wall 12a of the seat 8 of the caliper body 2 or, according to the direction of rotation of the disc, so that the second abutment surface 22 of the plate 16 is brought into abutment with the second side wall 12b of the seat 8 of the caliper body 2.

The contact between one of the abutment surfaces of the plate 16 and one of the side walls of the seat 8 of the caliper body 2 enables the braking force to be transferred from the pad 10 to the caliper body 2.

The energy possessed by the moving vehicle is dissipated by the action of the frictional forces, producing a proportional amount of heat most of which remains in the brake disc and, the remaining portion of which flows towards the caliper body, through the pad.

However, the heat produced is obstructed in its flow towards the side walls of the seat of the caliper body by the presence of the zones 42, 44 of the support surface 16a of the plate 16 which are free of friction material, since these zones space the friction material 18, in which the heat is produced, from the side walls of the seat 8.

In other words, the free zones, which act as elements for spacing the friction material 18 from the side walls of the seat 8 of the caliper body 2, produce a high temperature gradient between the friction material and the side wall of the seat 8.

The rotation of the brake disc during normal operation also causes air turbulence in the vicinity of the pad.

In particular, the first recess 46 and the second recess 48 enhance this turbulence, acting substantially as cooling ducts.

In fact, the air which passes over the friction material 18, the plate 16, and the seat 8 for the pad 10, helps to cool these members.

Moreover, the first recess and the second recess form ducts for discharging the dust which is released from the friction material 18 as a result of each braking operation.

These recesses, which are disposed in the vicinity of the disc, are advantageously in communication with the outside atmosphere through the opening 9 provided in the axial covering region of the caliper body 2.

The air turbulence caused by the rotation of the brake disc in a normal operating condition brings about cooling of the pad seat and entrainment of the dust towards the exterior.

Unusually, the disc brake pad according to the invention can limit the flow of heat between the pad and the caliper body which houses it.

In fact, principally in compact caliper-body constructions, the pad is substantially enveloped by the material of the caliper body and is in communication with the outside atmosphere through the opening provided in the caliper body.

The zones of the support surface for the friction material which are free of friction material advantageously form spacer elements which space the material from the side walls of the pad seat, obstructing the flow of heat generated by the friction material during braking, towards the caliper body.

Advantageously, the friction material is recessed towards the interior of the support surface of the pad and is spaced from the peripheral surface of the plate principally in the region of the abutment surfaces thereof.

This limits the flow of heat from the friction material towards the side walls of the seat which, during braking, are subject to large loads due to the abutment of the plate against them, limiting wear of the seat walls due to the effect of the loads and of the temperature.

Moreover, the provision of zones of the support surface of the plate which are free of friction material improves the reliability of the entire brake unit.

It is indeed true that, if the surface area of the friction material which is active during braking is reduced whilst its thickness is kept constant, in order to limit axial dimensions, the friction material must work at a higher specific pressure to achieve the same braking action.

As evidence of this, it suffices to stress that the currently established practice in the production of disc brake pads provides for the whole of the surface available on the plate to be occupied, up to the peripheral edge of the plate.

The object of this construction is to extend as far as possible the area of the friction material which is active during braking so as to reduce the specific working pressure of the material for a given braking power, increasing the average life expectancy of the pads.

The pads according to the invention have demonstrated that, although the surface area of the friction material which is active during braking is reduced, the reliability of the brake unit as a whole is improved thereby since the spacing of the friction material from the side walls of the seat improves the working conditions, reducing the flow of heat towards the caliper body.

According to a further advantageous aspect, the friction material is spaced from the side walls of the seat so that the lateral regions of the friction material are arranged radially relative to the brake disc with which the caliper is associated. In particular, this enables zones which are free of friction material to be provided close to the centre of the disc.

Another advantageous aspect of the pad according to the invention is that the zones free of friction material that are provided on the plate define recesses which act as cooling ducts. In fact, the normal air turbulence produced by the rotating brake disc is enhanced inside these recesses which form cooling ducts, since they are in communication with exterior.

Furthermore, the recesses act as ducts for discharging the dust which the friction material releases after each braking operation, advantageously preventing the dust from accumulating in the pad seat.

Naturally, in order to satisfy contingent and specific requirements, a person skilled in the art will be able to apply many modifications and variations to the above-described disc brake pad.

In a further variant, for example, the zones of the plate which are free of friction material have a general polygonal configuration defined, for example, by straight or curved portions of the lateral region of the friction material and/or of the abutment surface of the plate.

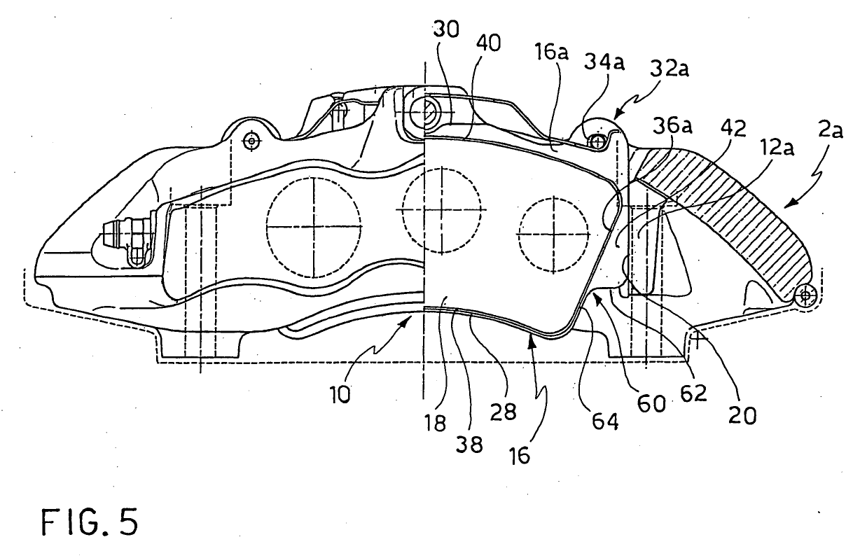

According to a further variant of the pad according to the invention (FIG. 5), the plate 16 for supporting the friction material 18 has, along its peripheral surface, the abutment surface 20, connected to the lower surface 28 by means of a re-entrant surface 60.

The re-entrant surface has a first portion 62 substantially perpendicular to the abutment surface 20 and a second portion 64 arranged substantially radially relative to the brake disk which can be associated with the caliper body that is to house the pad.

The friction material 18 is arranged on the support surface 16a of the plate 16 in a manner such that the lower arcuate region 38 faces towards the lower surface 28 of the plate 16 and the upper arcuate region 40 faces towards the upper surface 30 of the plate 16.

The lateral region 36a of the friction material 18, which is arranged substantially radially relative to the brake disc that can be associated with the caliper body which is to house the pad, faces towards the abutment surface 20 of the plate and defines, together with the abutment surface 20 and with the first portion 62 of the re-entrant surface 60, a zone 42 which is free of friction material.

The zone which is free of friction material is substantially triangular.

During braking, the abutment surface 20 of the plate 16 is brought into abutment with the side wall 12a of the seat 8 for the pad 10. The zone 42 which is free of friction material spaces the friction material from the abutment surface 20 in the region of the abutment between the plate 16 and the side wall 12a of the pad seat 8.

The second portion 64 of the re-entrant surface 60, which is not involved in the abutment during a braking operation, is recessed relative to the abutment surface 20 of the plate 16, towards and into alignment with the lateral region 36a of the friction material 18.

In a further variant, each half-portion of the caliper body is suitable for housing more than one pad, for example, two pads. Naturally, in this case, whilst the structure of the caliper body is modified for this purpose in accordance with methods known in the art, the particular characteristics of the pad according to the invention remain substantially unchanged.

Naturally these variants are also intended to be included within the scope of protection of the invention as defined by the appended claims.

What is claimed is:

1. A disc brake pad suitable for cooperating with a fixed-caliper disc brake comprising a caliper body provided with at least one seat suitable for housing the pad, in which
the seat is partially defined at least by a side wall, the pad comprising:
a plate which is defined by a peripheral surface having at least one abutment surface and which has a support surface for supporting friction material,
in which
in a braking configuration, the abutment surface of the peripheral surface of the plate is in abutment with the side wall of the seat of the caliper body,
the pad further comprising at least one spacer element suitable for spacing the friction material of the pad from the abutment surface of the plate.

2. A pad according to claim 1 in which the spacer element is suitable for limiting the flow of heat generated during braking, from the pad to the caliper body which houses it.

3. A pad according to claim 1 in which the spacer element is formed by a zone, which is free of friction material, and which is provided on the support surface of the plate.

4. A pad according to claim 1 in which the friction material is shaped in a manner such that its peripheral surface comprises at least one lateral region which faces towards the abutment surface when the friction material is supported by the plate.

5. A pad according to claim 1 in which the friction material is shaped in a manner such that its peripheral surface comprises at least one lower arcuate region.

6. A pad according to claim 5 in which the plate is shaped in a manner such that its peripheral surface comprises a lower surface.

7. A pad according to claim 6 in which the lower arcuate region of the friction material supported on the support surface follows the lower surface of the plate.

8. A pad according to claim 1 in which the friction material is shaped in a manner such that its peripheral surface comprises an upper arcuate region.

9. A pad according to claim 8 in which the plate is shaped in a manner such that its peripheral surface comprises an upper surface.

10. A pad according to claim 9 in which the upper arcuate region of the friction material supported on the support surface follows the upper surface of the plate.

11. A pad according to claim 4 in which the lateral region of the peripheral surface of the friction material is not arranged parallel to the abutment surface of the plate.

12. A pad according to claim 11 in which the lateral region of the peripheral surface of the friction material is recessed towards the interior of the plate.

13. A pad according to claim 4 in which the lateral region of the peripheral surface of the friction material at least partially defines, together with the abutment surface of the plate, a zone which is free of friction material.

14. A pad according to claim 13 in which the zone is substantially triangular.

15. A pad according to claim 3 in which the space defined between the zone of the plate which is free of friction material and the braking surface of the brake disc that can be associated with the pad forms a recess.

16. A pad according to claim 15 in which the recess forms a cooling duct which is in communication with the atmosphere outside the caliper body.

17. A pad according to claim 15 or claim 16 in which the recess forms a duct for discharging dust resulting from wear, dispersed by the friction material.

18. A pad according to claims 3 in which the braking surface of the brake disc which can be associated with the caliper body at least partially covers the zone of the support surface of the plate which is free of friction material.

19. A pad according to claim 18 in which the braking surface completely covers the zone of the support surface of the plate which is free of friction material.

20. A disc-brake caliper body suitable for housing a pad, said pad being suitable for cooperating with a fixed-caliper disc brake comprising said caliper body, said caliper body being provided with at least one seat suitable for housing the pad, in which
the seat is partially defined at least by a side wall, the pad comprising:
a plate which is defined by a peripheral surface having at least one abutment surface and which has a support surface for supporting friction material,
in which
in a braking configuration, the abutment surface of the peripheral surface of the plate is in abutment with the side wall of the seat of the caliper body,
the pad further comprising at least one spacer element suitable for spacing the friction material of the pad from the abutment surface of the plate.

21. A fixed disc-brake caliper comprising a caliper body according to claim 20.

22. A fixed caliper according to claim 21 further comprising a pad.

23. A disc brake comprising a fixed caliper according to claim 21 or claim 22.
